(19) United States
(12) Patent Application Publication
(10) Pub. No.: US 2006/0033305 A1
(43) Pub. Date: Feb. 16, 2006

(54) Cycle crank

(75) Inventor: Raymond Crozet, Saint Etienne (FR)

Correspondence Address: HESLIN ROTHENBERG FARLEY & MESITI PC, 5 COLUMBIA CIRCLE, ALBANY, NY, 12203, US

(73) Assignee: Stronglight SA, Saint Etienne (FR)

(21) Appl. No.: 11/201,860

(22) Filed: Aug. 11, 2005

(30) Foreign Application Priority Data
Aug. 13, 2004 (FR) 04.08939

(51) Int. Cl. B62M 1/02; G05G 1/14

(52) U.S. Cl. 280/259; 74/594.1

(57) ABSTRACT

A crank comprises two components, a crank body and a protective shield arranged to be assembled and connected together in a male-female configuration defining respective bearing, counter-bearing and contact zones with a connector holding them together. One end of the crank body is provided with an opening enabling the crankset axle to be fastened, and the other end is provided with a fork-shaped configuration. The shield comprises a ring arranged to receive the pedal axle, the fork-shaped end of the crank body comes to bear on the ring (2a) in a complementary counter-bearing assembly.

### CROSS REFERENCE TO RELATED APPLICATIONS

This application claims priority from French patent application no. 04.08939, filed on Aug. 13, 2004, the entire contents of which is hereby incorporated by reference herein.

### BACKGROUND OF THE INVENTION

The invention relates to the technical sector of cycle cranks.

Said cranks currently produced for many manufacturers are produced in aluminium or carbon composite materials and are designed in a single piece one end of which is arranged to receive a bearing for the pedal axle and the other end of which is arranged to be coupled to the crankset axle.

This one-piece type production is designed for all types of applications, whether racing or road bicycles and also trekking and all-terrain bikes

Much work and research has been carried out to improve the rigidity of the crank under the stresses of use, particularly for trekking and all-terrain bikes. With this in mind cranks have been designed using carbon-type composite materials. Production costs are, nevertheless, high. There is, however, the problem of the crank being torn from the crankset housing under extreme stress.

### BRIEF SUMMARY OF THE INVENTION

The applicant's approach therefore consists in creating a new and unexpected design of the crank while meeting various criteria of robustness, cost and lightness.

According to a first feature the crank has two components, the crank body and a shield, said crank body and shield being arranged to be assembled and connected together in a male-female configuration defining respective bearing, counter-bearing and contact zones with connecting means holding them together.

According to another feature the rear end of the crank body presents an extended section that is thinner than the rest of the crank body and constitutes the male part for assembly with the shield, the rear end being fork shaped.

### BRIEF DESCRIPTION OF THE DRAWINGS

These and other features will be better understood from the following description.

The description is of a non-limitative example and refers to the attached drawings where:

FIG. 1 is a perspective view of a cycle crank according to the invention before the two components, i.e. the shield and crank body, are assembled.

FIG. 2 is a view as per FIG. 1 after the crank has been assembled and created in the one-piece assembly.

FIG. 3 is a longitudinal cross-section view according to the invention, as per FIG. 2, including an additional arrangement with a reversible insert that modifies the pedalling range.

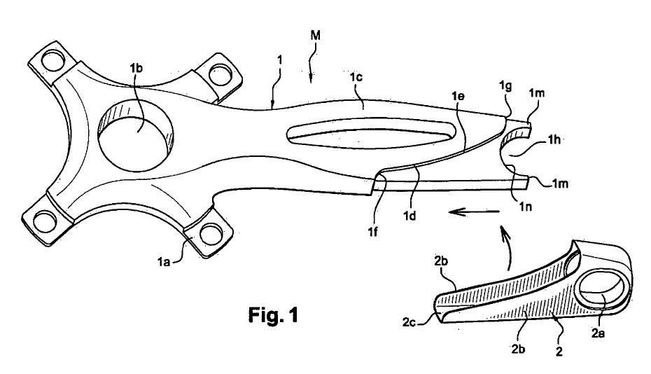

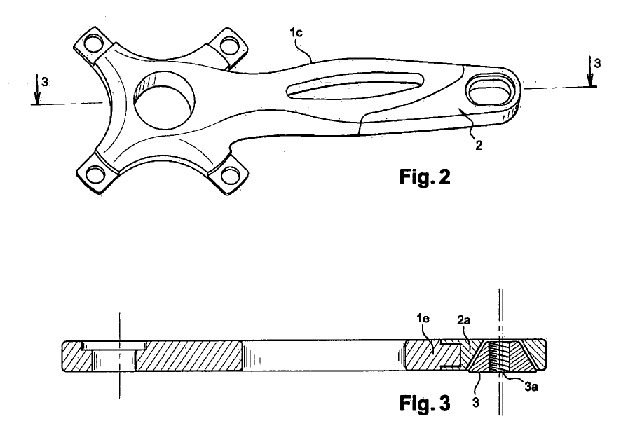

### DETAILED DESCRIPTION

In order to provide a clearer idea of the invention the following description is of a non-limitative example and refers to the attached drawings.

The overall cycle crank is referred to as (M).

The crank according to the invention comprises two components, the crank body (1) and a protective shield (2) that are assembled closely together to constitute a single part. “Crank” refers to both the right crank to which the chainwheels and a pedal are fastened and the left crank to which the other pedal is fastened.

The front section of the right crank body is arranged, using a known technique, with a plurality of arms (1a) the ends of which are used to fasten the chainwheels. The crank body also presents an opening (1b) between the arms that constitutes a square or notching for driving the crankset axle. The left crank presents the above-mentioned opening (1b) for coupling to the other end of the crankset axle.

According to the invention the rear end of the right and left crank body presents an extended section (1c) that is thinner than the rest of the crank body to constitute a male assembly part that receives a shield (2). For this purpose, said extension (1c) advantageously presents an abutment zone (1d) on the crank body with a curved configuration (1e) and, on either side of the configuration, facing return shapes (1f-1g) that constitute complementary contact and bearing zones for the shield.

The rear end (1h) is fork shaped with two points (1m) and a connection zone (1n) between them.

The crank body is produced in any suitable light, aluminum-type or other composite material.

The shield (2) fits onto the crank body in the reception zone described above and it defines and is also used as a fastening plane for the pedal axle.

To achieve this said shield comprises a cylindrical or oblong ring (2a) arranged to receive the pedal axle. The ring (2a) is protected by two identical parallel flanges (2b) located on either side of the ring that include a connecting zone with a bottom surface (2c). The shape of the flanges is complementary to that of the reception zone on the crank body and interlocks with the reception zone in a male-female connection whereas the fork shape of the crank body bears on the facing section of the ring. Bonding or adhesive and generally any means are used to create a fixed rigid connection that may be dismantled or otherwise.

The shield is produced in material with shock-resistance characteristics that are greater than those of the crank body, for example steel or other alloys and materials.

In an additional arrangement the ring (2a) formed in the shield is fitted in an advantageous and non limitative implementation to receive an insert (3) with a complementary profile. The insert presents a threaded hole (3a) that can either be in its axial plane or offset to receive the pedal axle. The offset enables the insert to be positioned in the ring in two positions to increase the cyclist's pedalling range.

The invention clearly shows the advantages. The new design of the left-right cranks is emphasised with the possibility of improved protection in the event of impact to the protective shield. A non limitative example of an assembly of the two components has been given. The new configuration also contributes to giving the cranks a new appearance which may also be a deciding factor in the purchase.

1. Cycle crank comprising a crank body and a protective shield arranged to be assembled and connected together in a male-female configuration defining respective bearing, counter-bearing and contact zones with connecting means holding them together, wherein one end of the crank body is provided with an opening enabling a crankset axle to be fastened, and an other end of the crank body is provided with a fork-shaped configuration,
the shield comprises a ring arranged to receive a pedal axle, and
the fork-shaped end of the crank body comes to bear on the ring in a complementary counter-bearing assembly.

2. Crank as claimed in claim 1, wherein the other end comprises a rear end of the crank body, the rear end of the crank body presents an extended section that is thinner than the rest of the crank body and constitutes a male part for assembly with the shield.

3. Crank as claimed in claim 2, wherein said extended section comprises an abutment zone with a curved configuration and, on either side of the configuration, facing return shapes that constitute complementary contact and bearing zones for the shield.

4. Crank as claimed in claim 2, wherein the fork-shaped rear end of the crank body comprises two points and a connection zone between said points for coming into contact with a complementary section on the shield.

5. Crank as claimed in claim 3, wherein the shield further comprises two identical parallel flanges located on either side that include a connecting zone with a bottom surface a shape of said flanges being complementary to that of the abutment zone on the crank body.

6. Crank as claimed in claim 1, wherein the crank body is connected to the shield by bonding.
